(19) United States
(12) Patent Application Publication
(10) Pub. No.: US 2009/0282259 A1
(43) Pub. Date: Nov. 12, 2009

(54) NOISY LOW-POWER PUF AUTHENTICATION WITHOUT DATABASE

(75) Inventors: Boris Skoric, Eindhoven (NL); Pim Theo Tuyls, Eindhoven (NL); Antoon Marie Henrie Tombeur, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/296,682

(22) PCT Filed: Apr. 10, 2007
(86) PCT No.: PCT/IB2007/051263

§ 371 Date: Oct. 10, 2008

(30) Foreign Application Priority Data
Apr. 11, 2006 (EP) 06112474.9

(51) Int. Cl. H04L 9/32; G06F 21/00

(52) U.S. Cl. 713/185; 726/20

(57) ABSTRACT

The present invention relates to a method of authenticating, at a verifier (210), a device (101, 201) comprising a physical token (102), a system for performing authentication and a device comprising a physical token which provides measurable parameters. A basic idea of the present invention is to provide a secure authentication protocol in which a low-power device (101, 201), for example an RFID tag, comprising a physical token (102) in the form of a physical uncloneable function (PUF) is relieved from performing cryptographic operations or other demanding operations in terms of processing power. To this end, a PUF device (101, 201) to be authenticated verifies if it in fact is being queried by an authorized verifier. For instance, an RFID tag comprising a PUF (102) may be arranged in a banknote which a bank wishes to authenticate. This verification is based on the bank's unique ability to reveal concealed data, such as data having been created in an enrolment phase at which the RFID tag (or actually the PUF) was registered with the bank. Now, the RFID tag again challenges its PUF to create response data sent to the verifier. The verifier checks whether the response data is correct and, if so, authenticates the device comprising the physical token, since the device is able to produce response data that corresponds to response data concealed and stored in the enrolment phase.

The present invention relates to a method of authenticating, at a verifier, a device comprising a physical token, a system for performing authentication and a device comprising a physical token which provides measurable parameters.

A Physical Uncloneable Function (PUF) is a structure used for creating a tamper-resistant environment in which parties may establish a shared secret. A PUF is a physical token to which an input—a challenge—is provided. When the challenge is provided to the PUF, it produces a random analog output referred to as a response. Because of its complexity and the physical laws it complies with, the token is considered to be ‘uncloneable’, i.e. unfeasible to physically replicate and/or computationally model. A PUF is sometimes also referred to as a Physical Random Function. A PUF can be substantially strengthened if it is combined with a control function. In practice, the PUF and an algorithm that is inseparable from the PUF is comprised within a tamper-resistant chip. The PUF can only be accessed via the algorithm and any attempt to by-pass or manipulate the algorithm will destroy the PUF. The algorithm, which is implemented in hardware, software or a combination thereof, governs the input and output of the PUF. For instance, frequent challenging of the PUF is prohibited, certain classes of challenges are prohibited, the physical output of the PUF is hidden, only cryptographically protected data is revealed, etc. Such measures substantially strengthen the security, since an attacker cannot challenge the PUF at will and cannot interpret the responses. This type of PUF is referred to as a controlled PUF (CPUF).

An example of a PUF is a 3D optical medium containing light scatterers at random positions. The input—i.e. the challenge—can be e.g. angle of incidence of a laser beam that illuminates the PUF, and the output—i.e. the response—is a speckle pattern produced by the light scatterers as a result of a particular angle of incidence. This response may be detected with a camera and quantized into a cryptographic key.

Another way of creating a PUF that may be used as a source of cryptographic key material is to cover an integrated circuit (IC) with a coating in which dielectric particles are interspersed. These particles typically have different dielectric constants and more or less random shapes, dimensions and locations due to the production process. Sensor elements are arranged at a top metal layer of the IC to locally measure capacitance values at different coating positions. In this example, the coating itself constitutes a physical uncloneable function. As a result of the random nature of the dielectric particles, the measured capacitance values make excellent key material. The IC provided with a PUF in the form of a coating measures capacitances and converts the capacitance values into bit strings from which the cryptographic keys are derived.

In an enrolment phase, a challenge is provided to the PUF, which produces a unique and unpredictable response to the challenge. The challenge and the corresponding response may be stored at a verifier with whom authentication subsequently is to be undertaken. Typically, in an authentication phase, the verifier provides a proving party with the challenge that was stored in the enrolment phase. If the proving party is able to return a response to the challenge, which response matches the response that was stored in the enrolment phase, the proving party is considered to have proven access to a shared secret, and is thus authenticated by the verifier. Both the enrolment phase and the authentication phase should be undertaken without revealing the shared secret, i.e. the response, which typically involves setting up secure channels by means of encryption. The inverse situation is also known in the art: a processor equipped with a PUF can verify that it is communicating with a user who has knowledge of prior measurements of its PUF. Hence, a device arranged with a PUF can authenticate users seeking access to the device.

PUFs are e.g. implemented in tokens employed by users to authenticate themselves and thus get access to certain data, services or devices. The tokens may for example comprise smartcards communicating by means of radio frequency signals or via a wired interface (such as USB) with the device to be accessed. PUFs can be used to authenticate a wide range of objects and devices, e.g. smartcards, SIM-cards, credit cards, banknotes, value papers, RFID (Radio Frequency Identification) tags, security cameras, etc. Hence, PUFs are well-suited for application in e.g. DRM (Digital Rights Management), copy protection, brand protection and counterfeit detection. Furthermore, PUFs offer an inexpensive method of tamper evidence.

Ideally, a PUF-based authentication protocol should satisfy all of the following properties:

1. ability to discriminate: there must be enough differences between PUF properties to uniquely identify PUFs;
2. security: secret keys derived from a PUF must be protected. If they are compromised, an attacker can impersonate the PUF device (forgery, counterfeiting, identity theft, etc.). These secrets must be protected from eavesdroppers, malicious verifiers/third parties and hackers attempting to attack the PUF device;
3. noise tolerance: all PUF measurements are noisy to some degree. If a cryptographic operation is applied to a PUF output, an error-correcting code typically has to be applied first, since the actual task of a cryptographic function is to garble an input supplied to it. Without error correction, small discrepancies in input data result in great discrepancies in output data;
4. low cost: appliances used by a verifier (e.g. ATM machines) are in general allowed to be expensive. However, devices used by a party to be authenticated (e.g. ATM withdrawal cards) must be inexpensive.

RFID tags are used as inexpensive identifiers and are expected to replace barcodes. The most simple tags contain only an identifying number (ID) and an Electronic Product Code (EPC). However, tags that are somewhat more expensive can also contain e.g. a PIN code, some extra memory and—a modest amount of—computational power. It has been proposed to use RFID tags for authentication and anti-counterfeiting purposes, e.g. for the detection of banknote counterfeiting.

A growing number of applications demand that the authentication protocol can be run on low-power devices, in addition to satisfying the required authentication protocol properties given in the above. Examples are RFID tags with embedded PUFs, smartcards with integrated fingerprint sensor, “electronic dust” applications, etc. These devices have moderate processing power capabilities, and are in general too weak to perform cryptographic operations such as encryption, decryption, signing and signature checking. Furthermore, they are typically too weak to perform error-correcting algorithms on noisy measurements. However, they generally have enough power to generate random numbers and to compute hash functions. A problem in the prior art is how to guarantee security when a low-power device is not allowed to use error correction and cryptographic algorithms like AES, DES, RSA, ECC, etc.

In some applications, such as banknote verification in bulk quantities, speed is an important requirement. A problem with cryptographic operations is that they require an extensive amount of processor time.

Further, maintaining a database of enrolment measurements is cumbersome for a verifier. When holding a record for a great number of PUFs, it is clearly advantageous to avoid the necessity of a database altogether.

An object of the present invention is to overcome some of the problems in the prior art described in the above. In particular, it is an object of the present invention to provide a secure authentication protocol that also can be run on low-power devices that do not have enough processing power to perform cryptographic operations such as encryption, decryption, signing, signature checking and error-correction on noisy measurements. A further object of the present invention is to provide a secure authentication protocol in which a verifier does not have to maintain a database of enrolment measurements for physical tokens.

These objects are attained by a method of authenticating a physical token at a verifier in accordance with claim 1, a system for performing authentication in accordance with claim 19 and a device comprising a physical token which provides measurable parameters in accordance with claim 25.

In a first aspect of the invention, there is provided a method of authenticating a physical token at a verifier comprising the steps of receiving, at the verifier, a first set of concealed response data from the device, which response data was derived from the physical token, concealed and stored in the device during enrolment and revealing the concealed response data and sending it to the device. Further, the method comprises the steps of challenging, at the device, the physical token with a first challenge that was employed to derive the first set of response data, to derive response data and comparing the derived response data with the first set of response data received from the verifier, and challenging, if the derived response data corresponds to the first response data set received from the verifier, the physical token with a second challenge that was employed to derive a second set of response data from the physical token and which second set was concealed and stored in the device during enrolment, to derive response data. Then, the second set of concealed response data and the response data derived from the second challenge is sent to the verifier, which reveals the second set of concealed response data and compares the second set of response data with the response data derived from the second challenge, wherein the device is considered to be authenticated if there is correspondence between the two data sets.

In a second aspect of the invention, there is provided a system for performing authentication, said system comprising a verifier and a device comprising a physical token. In the system, the verifier is arranged to receive, from the device, a first set of concealed response data, which response data was derived from the physical token, concealed and stored in the device during enrolment, and reveal the concealed response data and send it to the device. The device is arranged to derive response data by challenging the physical token with a first challenge that was employed to derive the first set of response data, compare the derived response data with the first set of response data received from the verifier and derive response data by challenging, if the derived response data corresponds to the first response data set received from the verifier, the physical token with a second challenge that was employed to derive a second set of response data from the physical token and which second set was concealed and stored in the device during enrolment. Further, the device is arranged to send the second set of concealed response data and the response data derived from the second challenge to the verifier, which reveals the second set of concealed response data and compares the second set of response data with the response data derived from the second challenge, wherein the device is considered to be authenticated if there is correspondence between the two data sets.

In a third aspect of the invention, there is provided a device comprising a physical token which provides measurable parameters, which device further comprises sensor elements for measuring the parameters provided by the physical token, logic circuitry for processing data supplied to it in a noninvertible function, at least one memory for storing concealed response data derived from said physical token during enrolment of the device and communication means for communicating with an external entity.

A basic idea of the present invention is to provide a secure authentication protocol in which a low-power device, for example an RFID tag, comprising a physical token in the form of a physical uncloneable function (PUF) is relieved from performing cryptographic operations or other demanding operations in terms of processing power. To this end, a PUF device to be authenticated verifies if it in fact is being queried by an authorized verifier. For instance, an RFID tag comprising a PUF may be arranged in a banknote which a bank wishes to authenticate. This verification is based on the bank's unique ability to reveal concealed data, such as data having been created in an enrolment phase at which the RFID tag (or actually the PUF) was registered with the bank. In the following, a verifying party is exemplified in the form of a bank and a party to be authenticated, i.e. a proving party, is embodied in the form of a banknote equipped with an RFID tag comprising a PUF. Concealing of data may be accomplished by means of symmetric or asymmetric encryption and accordingly, revealing of data is effected by means of decryption.

In detail, the bank receives a first set of concealed response data from the RFID tag. This response data was previously derived from the PUF of the RFID tag, concealed by the bank and stored at the tag during enrolment. Thereafter, the bank reveals the concealed response data and sends it in plaintext to the tag. The tag challenges its PUF, using a challenge that was employed to derive the first enrolled set of response data, to derive response data and compares the derived response data with the first set of response data received from the verifier. If the derived response data corresponds to the first response data set received from the bank, it has been verified that the bank was able to reveal the concealed response data that was sent to it, and hence must have had access to means for revealing the concealed response data, for instance a decryption key. Since the RFID tag now is convinced that it is communicating with the bank (or actually any authorized party in possession of the decryption key), it proceeds to the next step of the authentication protocol.

Now, the RFID tag again challenges its PUF to create response data by using a challenge that previously was employed to derive a second set of response data of the physical token, and which second set was concealed by the verifier/enroller and stored at the token, during enrolment. The second set of concealed response data and the response data derived from the second challenge are sent to the verifier. The verifier reveals the second set of concealed response data and compares the second set of response data with the response data derived from the second challenge. If there is correspondence, the device comprising the physical token is considered to be authenticated, since it is able to produce response data that corresponds to response data concealed and stored in the enrolment phase.

It should be noted that the party performing the actual enrolment (i.e. the enroller) is not necessarily the same as the party who subsequently performs verification (i.e. the verifier). For instance, a bank may centrally enroll a device, while verification of the device typically is undertaken at a local bank office.

Advantageously, the present invention enables application of a secure authentication protocol in an environment in which low-power devices have limited resources in terms of processing power, in particular for carrying out cryptographic operations. Further, application of the present invention frees a verifier from the obligation of maintaining a database of enrolment data.

Enrolment of the device comprising the physical token is typically carried out with the device set in a bootstrapping or initializing mode, in which the device reveals a number of sets of PUF response data. The verifier receives the response data sets from the device and conceals them, for example by means of encrypting them with a secret symmetric key held by the verifier. The sets of concealed response data are thereafter stored in the PUF device and the bootstrapping mode is permanently disabled. It should be noted that the term “response data” relates to digital data derived from the actual “raw” analog response of the PUF. The response data may consist of an A/D conversion of the raw response itself, but as will be described, it may also consist of a noise-corrected response. A person skilled in the art can envisage a number of ways to provide response data. For instance, the raw analog response may be processed so as to appropriately extract information from it.

In an advantageous embodiment of the present invention, the response data comprises noise-corrected data based on a response of the physical token and noise-correcting data which in the following is referred to as helper data. Helper data is typically employed to provide noise-robustness in a secure way. A response attained during enrolment is not necessarily identical to a (theoretically identical) response attained during an authentication phase. When a physical property is measured, such as a PUF response, there is always random noise present in the measurement, so the outcome of a quantization process to convert an analog property into digital data will differ for different measurements of the same physical property. Hence, identical challenges for a PUF do not necessarily produce the same responses. In order to provide robustness to noise, helper data is derived and stored during enrolment. The helper data will be used during authentication to achieve noise robustness. Helper data is considered to be public data and only reveals a negligible amount of information about secret enrolment data derived from the response.

In an exemplifying helper data scheme, the helper data Wand enrolment data S are based on a response R of a PUF via some appropriate function F_{G}, such that (W, S)=F_{G}(R). The function F_{G} might be a randomized function which enables generation of many pairs (W, S) of helper data Wand enrolment data S from one single response R. This allows the enrolment data S (and hence also the helper data w) to be different for different enrolment authorities.

The helper data is based on the enrolment data and the response of the PUF and is chosen such that, when a delta-contracting function is applied to the response R and the helper data W, the outcome equals the enrolment data S. The delta-contracting function has the characteristic that it allows the choice of an appropriate value of the helper data such that any value of data which sufficiently resembles the response results in the same output value, i.e. data which is identical to the enrolment data. As a consequence, G(R, W)=G(R′, W)=S, if R′ resembles R to a sufficient degree. Hence, during authentication, a noisy response R′ will, together with the helper data W, result in verification data S′=G(R′, W) which is identical to the enrolment data S. The helper data W is arranged such that no information about the enrolment data S or the verification data S′ is revealed by studying the helper data.

In case a helper data scheme is employed, the verifier constructs, in the enrolment phase, helper data Wand enrolment data S from the raw response R received from the PUF device. Thereafter, the enrolment data is concealed and stored together with the (plaintext) helper data in the PUF device. In the authentication phase, the response of the PUF is processed at the PUF device with the helper data as has been described in the above, and the response data sent to the verifier thus comprises the enrolment data S in case helper data is employed and not the raw response R. It should be noted that the helper data alternatively may be concealed and stored in the device. In that case, the concealed helper data is sent to the verifier in the authentication phase, which reveals it and sends it in plaintext to the device comprising the physical token.

In another embodiment of the present invention, which advantageously may be employed to further strengthen the security of the authentication protocol, verification data in the form of a random number x is generated by the verifier during enrolment of the device comprising the physical token. The number x is then encrypted and signed by the verifier and stored in the device comprising the token. Further, a hashed copy of x is preferably stored in the device. In the authentication phase, the verifier receives the signed and concealed x from the device comprising the physical token. The verifier checks the signature. If the signature is invalid, he considers the token to be counterfeit or otherwise unauthentic. On the contrary, if the signature is valid, the verifier reveals the concealed x and sends x to the device in plaintext. The device then applies a noninvertible function to x. This is the same noninvertible function that was employed during enrollment, e.g. a hash function.

The device then compares the output of the hash function to the hash value stored in the device. If the hash values do not match, the device considers the verifier to be unauthorized and will not proceed to the next step of the authentication protocol. The next step is the step of deriving response data and comparing it to response data received from the verifier.

In further embodiments of the present invention, data to be verified, i.e. response data and verification data, may be provided with a valid digital signature in the enrolment phase. Then, during authentication, the verifier checks whether concealed response data and verification data have been provided with a valid signature. If not, the protocol is terminated, since adequate protocol security cannot be guaranteed.

In still another embodiment, the physical token is cryptographically bound to the device in which it is comprised. Assuming that the physical token is comprised in an RFID tag arranged in a banknote: it is then possible to bind e.g. the serial number of the banknote to the PUF. One way of doing this is to append the serial number to one or both of the PUF responses under encryption. The advantage of this embodiment is that removing an RFID tag from one banknote and embedding it in another results in a mismatch that easily can be detected by the verifier.

Further features of, and advantages with, the present invention will become apparent when studying the appended claims and the following description. Those skilled in the art realize that different features of the present invention can be combined to create embodiments other than those described in the following. Even though a banknote arranged with an RFID tag comprising a PUF has been used as an example of a party to be authenticated and a bank has been exemplified as a verifying party, it should be understood that the present invention can be applied in many environments in which a secure authentication protocol can be used. As has been mentioned in the above, the tokens may for example be comprised in smartcards communicating by means of radio frequency signals or via a wired interface (such as USB) with the device to be accessed. PUFs can be used to authenticate a wide range of objects and devices, e.g. smartcards, SIM-cards, credit cards, banknotes, value papers, RFID (Radio Frequency Identification) tags, security cameras, etc.

A detailed description of preferred embodiments of the present invention will be given in the following with reference made to the accompanying drawings, in which:

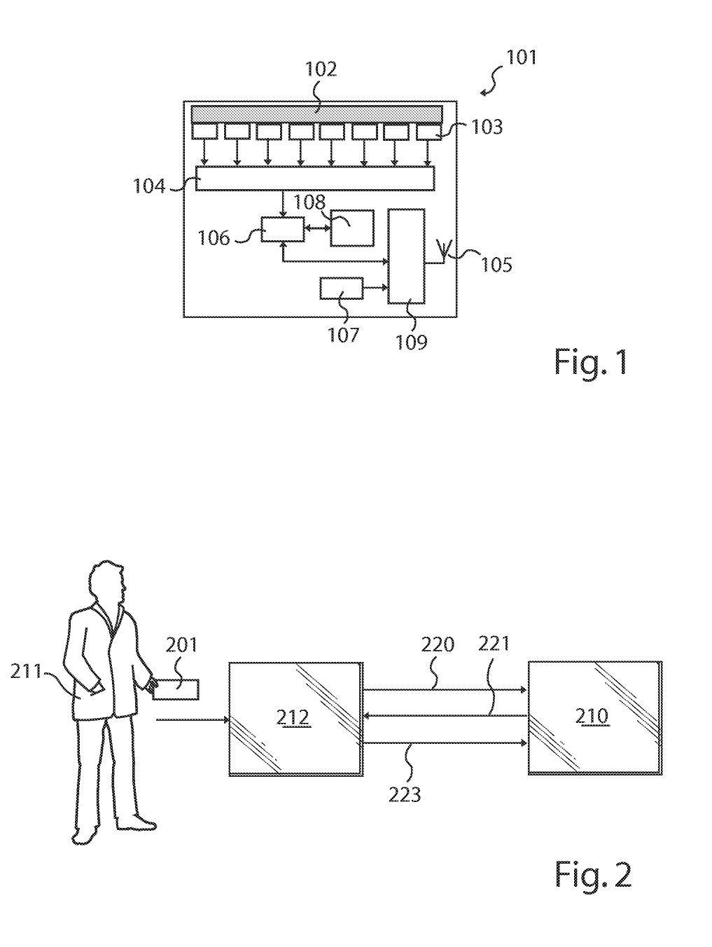

FIG. 1 shows a device comprising a physical token according to an embodiment of the present invention.

FIG. 2 shows an exemplifying embodiment of the present invention in which a bank note that comprises an RFID tag is to be authenticated at a bank.

FIG. 1 shows a device 101, e.g. an RFID tag, comprising a physical token 102 which provides measurable parameters for authentication according to an embodiment of the invention. The physical token, which also is referred to as a physical uncloneable function (PUF) may be embodied in the form of a coating, or a part of a coating covering the device 101. In the coating, dielectric particles are interspersed. These particles typically have different dielectric constants and are of random size and shape. Sensor elements 103 are arranged in the RFID tag for locally measuring capacitance values at different coating positions, thereby creating different response data depending on which sensor elements are read. As a result of the random nature of the dielectric particles, the measured capacitance values make excellent crypto material.

An A/D-converter 104 is further comprised in the RFID tag for converting analog capacitance values into bit strings from which cryptographic data can be derived. It should be noted that there exist PUFs known as “silicon PUFs”, which produce raw data that is very close to digital format, and which raw data can be processed as if it was completely digital. In that case, there is no need to include an A/D-converter in the device 101.

The device 101 is typically arranged with an input via which data can enter, and an output via which data can be provided. In the case of an RFID tag, data is input/output via an antenna 105 and an RF interface 109. The device 101 typically comprises memories in the form of a RAM 106 for storing data of intermediate character (e.g. response data derived from the sensors) and a ROM 107 for storing data of permanent character (e.g. concealed response data, noise-correcting data and other data stored in the enrolment phase).

For implementation of a PUF 102 and in an RFID tag 101, the following parameters must be complied with:

(a) low-power design (no battery “on board”, supply-power must be derived from an external electromagnetic field),
(b) relatively high-speed circuitry should be used (e.g. for fast high volume checking of banknotes), and
(c) IC process and silicon area costs.

Currently, RFID tags are fabricated in a CMOS IC process, because of the low cost of CMOS in general, the low-power circuit design which is possible in this technology, and the suitability for embedding memory circuits with these processes.

Because of these design parameter, a microprocessor cannot be embedded on low-cost, low-power devices such as RFID tags. Therefore, the relatively simple crypto-calculations enabled by the present invention can be performed by “hard-wired” crypto logic, i.e. low-power, standard logical gates (logical NAND and NOR functions). Once these mathematical crypto-functions have been described in e.g. a VHDL (Very high speed integrated circuit Hardware Description Language) format, the hard-wired circuit can nowadays be automatically generated by a place & route design tool. The crypto logic, which typically performs operations such as calculating hash functions is denoted by block 108. Circuitry which is implemented by means of VHDL is realized in logic devices such as ASICs (Application Specific Integrated Circuits), an FPGAs (Field Programmable Gate Arrays), a CPLD (Complex Programmable Logic Devices), etc.

In an enrolment phase, where a device 101 as shown in FIG. 1 is registered at an enroller/verifier, the device comprising a physical token 102 is set in a bootstrapping or initializing mode. In the following, it is assumed that a bank enrolls RFID tags according to FIG. 1, which tags subsequently are to be comprised in e.g. banknotes. In the bootstrapping mode, the device reveals at least two sets of PUF response data R₁, R₂, which data are based on capacitance measurements performed by the sensors 103. The bank receives the response data R₁, R₂ from the device and conceals them, for example by means of encrypting them with a secret key K (symmetric or asymmetric) held by the bank. The sets of encrypted response data E_{K}(R₁), E_{K}(R₂) are thereafter stored in the ROM 107 and the bootstrapping mode is permanently disabled.

In an embodiment of the present invention, the bank provides the encrypted response data E_{K}(R₁), E_{K}(R₂) with a digital signature by means of a private key held by the bank. The signature is in the following denoted $E_{K}(R₁), $E_{K}(R₂). The providing of a signature by the bank is not essential for carrying out the authentication protocol of the present invention. However, it is preferred as it substantially strengthens the authentication protocol in terms of security.

With reference to FIG. 2, in the authentication phase, when a device 201 is to be authenticated at a verifier in the form of bank 210, the first set $E_{K}(R₁) of signed and encrypted response data is provided to the bank in step 220. The device to be authenticated may be an RFID tag comprised in a bank note or, as illustrated in FIG. 2, a withdrawal card 201 with which a bank customer 211 wishes the withdraw money by inserting it in an automatic teller machine (ATM) 212. The bank checks that a valid signature has been provided and, if so, decrypts the encrypted data and sends the resulting plaintext data R₁, in step 221, to the withdrawal card 201 via the ATM 212.

When receiving the plaintext response data R₁, the device 201 challenges its physical token with the challenge that was employed during enrolment to derive the response data R₁. Another set R₁′ of response data is thus derived and is compared with the response data R₁ received from the bank 210. The comparing of the two response data sets may be undertaken by employing a well-known comparing scheme in which a measure of distance between two data sets is calculated, e.g. a Hamming distance or a Euclidean distance. If there is correspondence between the two sets (i.e. the calculated distance does not exceed a predetermined threshold value), it has been verified that the bank was able to decrypt the encrypted response data $E_{K}(R₁) that was sent to it, and hence must have had access to a corresponding decryption key. Since the withdrawal card now is convinced that it is communicating with the bank, it proceeds to the next step of the authentication protocol.

In this next step, the device 201 challenges its PUF with a second challenge that was employed to derive a second set of response data during enrolment and which was signed, encrypted and stored in the device. The device sends, to the bank 210 via the ATM 212 in step 222, the second set R₂′ of response data and the signed and encrypted response data $E_{K}(R₂) that was stored at the device in the enrolment phase. The bank checks that the signature is valid and, if so, decrypts the encrypted response data. The bank then compares the two sets of response data R₂, R₂′ (using e.g. a Hamming distance calculation). If there is correspondence between the two sets R₂, R₂′ of response data, the device 201 is authenticated at the bank 210, since it clearly is able to produce response data that corresponds to response data that was encrypted by the bank and stored in the device during the enrolment phase.

In another embodiment of the present invention, as previously has been discussed, further parameters are used for providing security to the authentication protocol. During enrolment, when the device has been set in a bootstrapping mode, noise-correcting data/helper data Wand enrolment data S are created based on a response R of the PUF via some appropriate function F_{G}, such that (W, S)=F_{G}(R). Thereafter, the response data in the form of enrolment data S is signed, encrypted and stored together with the helper data Win the PUF device. Further, the bank generates verification data in the form of a random number x. The number x is then encrypted, signed and stored at the device. Further, a hashed copy of x, H(x), is preferably stored at the device. Hence, in this particular embodiment, the device stores $E_{K}(S₁), $E_{K}(S₂), $E_{K}(x), W, H(x) in its ROM. Thereafter, the bootstrapping mode is permanently disabled.

With reference to FIG. 2, in the authentication phase, when a device 201 is to be authenticated at a verifier in the form of bank 210, the first set $E_{K}(S₁) of signed and encrypted response data is provided to the bank in step 220 together with the signed and encrypted random number $E_{K}(x). The device to be authenticated may be an RFID tag comprised in a bank note which a bank customer 211 wishes deposit with the bank via a money depositing machine 212. The bank checks that a valid signature has been provided and, if so, decrypts the encrypted response data and random number and sends the resulting plaintext data S₁ and x, in step 221, to the bank note 201 which is situated in the depositing machine 212.

When receiving the plaintext data S₁ and x, the device 201 applies a hash function to the random number x. If the resulting hash value H(x) corresponds to the hash value H(x) that was stored in the ROM of device 201, the device proceeds to the step of challenging its physical token with the challenge that was employed during enrolment to derive the response data R₁ on which the received enrolment data S₁ is based. On the other hand, if the hash values do not correspond to each other, the authentication protocol is aborted. The token outputs a raw response R₁′, and the device 201 uses the noise correcting helper data W that is stored in the ROM of the device to produce response data S₁′. The response data S₁′ is compared with the response data S₁ received from the bank 210, and if there is correspondence between the two sets, the bank must have had access to the decryption key required to decrypt the encrypted response data $E_{K}(S₁).

Thereafter, the device 201 challenges its PUF with a second challenge that was employed to derive a second set of response data during enrolment and which was signed, encrypted and stored in the device. The device processes the derived raw response R₂ with the stored helper data to create a second set of response data S₂. The device sends in step 222, to the bank 210 via the depositing machine 212 in which the bank note is located, the second set S₂′ of response data and the signed and encrypted response data $E_{K}(S₂) that was stored at the device in the enrolment phase. The bank checks that the signature is valid and, if so, decrypts the encrypted response data. The bank then compares the two sets of response data S₂, S₂′ (using e.g. a Hamming distance calculation). If there is correspondence between the two sets S₂, S₂′ of response data, the device 201 is authenticated at the bank 210, since it clearly is able to produce response data that corresponds to response data that was encrypted by the bank and stored in the device during the enrolment phase.

It should be noted that the user 211 in other applications may communicate directly with the bank 210 via his/her device 201 that comprises a physical token. However, the bank 210 typically comprises some kind device reader (for example an ATM 212) via which the user 211 communicates with the bank. In general, the device reader 212 is a quite passive device, which normally acts as an interface between the user and the authority with which the user wishes to perform a round of authentication.

In a further embodiment of the invention, as has been mentioned in the above, the physical token can be cryptographically bound to the device in which it is comprised. This cryptographic binding may be effected by means of associating response data of the physical token with an identifier of the device in which the token is comprised, and encrypting the data created by the association and storing it in the device. For instance, during enrolment, response data may be concatenated to the serial number of the bank note which embodies the device in which a physical token is comprised. The response data and serial number data is then e.g. signed and encrypted, which results in $E_{K}(S₂, serial number). This encrypted data is thereafter stored in the bank note and the physical token comprised therein is thus cryptographically bound to the bank note. As is understood by the skilled person when studying this embodiment, a number of alternatives are possible for accomplishing the binding. For instance, a generated random number x can be concatenated to the serial number and the concatenated data can be hashed, resulting in H(x, serial number).

The helper data may also be encrypted and stored at the device during enrolment. Hence, by storing e.g. $E_{K}(x, W), attackers are further impeded from breaking the authentication protocol. Moreover, the hashed random number, H(x), may be encrypted and stored in the device during enrolment. Storing $E_{K}(H(x)) is an additional measure to be taken for improving protocol security.

A further measure to be taken to strengthen security is to provide the authentication protocol with integrity. By providing integrity, only authorized parties of the protocol are capable of modifying exchanged data. If an attacker attempts to modify data sent between authorized parties, it will not go unnoticed. The provision of integrity may be achieved by having the enroller, in the enrolment phase, apply a hash function to for instance the response data R₁ concatenated with the hashed random number H(x), which results in the hashed data H(R₁∥H(x)). The hashed data is thereafter stored in the device of the party to be authenticated and bootstrapping mode is disabled. Now, if either R₁ or H(x) (or both) is manipulated during transfer between the party to be authenticated and the verifier, the hash value H(R₁∥H(x)) that is computed by the device will differ from the value that was stored in the device during enrolment, and manipulation will thus be detected.

Properties of a PUF may slowly change over time due to e.g. mechanical wear, which could have the effect that a verifier erroneously rejects a PUF. As a consequence, it is advantageous if parameters, which are stored during enrolment in the device comprising the PUF, could be updated as PUF properties change over time.

With reference again to FIG. 2, in an embodiment of the invention, which enables updating of parameters stored in the device during enrolment, the verifier 210 receives, from the device 201 in step 222, the second set R₂′ of response data and the signed and encrypted response data $E_{K}(R₂) that was stored at the device in the enrolment phase. If PUF properties have changed, there is a risk that the second set R₂′ of response data derived during authentication differs from the corresponding response data R₂ derived during enrolment, and the device will (erroneously) be rejected. To overcome this potential problem, the verifier performs the update (on a more or less continuous basis depending on the degree of PUF property drift in the device) by encrypting and signing the received R′₂, which results in $E(R′₂), and replaces $E(R₂) stored in the device during enrolment with $E(R′₂). Note that the signing of the encrypted response data only can be undertaken by the verifier if the verifier also was the enroller. Further, the update is only allowed if the verifier is able to authenticate the device by means of the received plaintext data R′₂ and the encrypted response data $E_{K}(R₂).

To further improve updating of parameters stored in the device during enrolment, the verifier 210 also updates the first set of encrypted response data $E_{K}(R₁) stored in the device during enrolment and received from the device 201 in step 220. In the description of preferred embodiments of the invention given in the above, the verifier cannot update the first set of response data R₁, since this first set is not revealed by the device. Further, the verifier cannot place the device in its “bootstrapping mode” for a second time. Thus, the device 201 sends the derived response data R′₁ along with the plaintext data R′₂ and the encrypted response data $E_{K}(R₂) in step 222. As in the previous embodiment, the verifier performs the update by encrypting and signing the received R′₂, which results in $E(R′₂), and replaces $E(R₂) stored in the device during enrolment with $E(R′₂), if the verifier is able to authenticate the device by means of the received plaintext data R′₂ and the encrypted response data $E_{K}(R₂). Now, the verifier also encrypts and signs the received R′₁, which results in $E(R′₁), and replaces $E(R₁) stored in the device during enrolment with $E(R′₂). This does not result in a breach of security, since the device 201 only will send the response data R′₁ to the verifier 210 in step 222, if the verifier shows in step 221 that it knows a set of response data R₁ which resembles R′₁ to a sufficient degree. Again, the update is only allowed if the verifier is able to authenticate the device by means of the received plaintext data R′₂ and the encrypted response data $E_{K}(R₂).

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of authenticating, at a verifier (210), a device (101, 201) comprising a physical token (102), the method comprising the steps of:
receiving, at the verifier, a first set of concealed response data from the device, which response data was derived from the physical token, concealed and stored in the device during enrolment;
revealing the concealed response data and sending it to the device;
challenging, at the device, the physical token with a first challenge that was employed to derive the first set of response data, to derive response data and comparing the derived response data with the first set of response data received from the verifier;
challenging, if the derived response data corresponds to the first response data set received from the verifier, the physical token with a second challenge that was employed to derive a second set of response data from the physical token and which second set was concealed and stored in the device during enrolment, to derive response data;
sending the second set of concealed response data and the response data derived from the second challenge to the verifier;
revealing, at the verifier, the second set of concealed response data and comparing the second set of response data with the response data derived from the second challenge, wherein the device is considered to be authenticated if there is correspondence between the two data sets.

2. The method of claim 1, wherein the step of receiving a first set of concealed response data at the verifier (210) further comprises the step of:
checking whether the first set of concealed response data is provided with a valid digital signature and, if so, performing the step of revealing the first set of concealed data and sending it to the device (201).

3. The method of claim 1, further comprising the step of:
checking, at the verifier (210), whether the second set of concealed response data is provided with a valid digital signature and, if so, performing the step of revealing the second set of concealed response data and comparing the second set of response data with the response data derived from the second challenge.

4. The method of claim 1, further comprising the steps of:
receiving, at the verifier (210), concealed verification data from the device (201), which verification data was concealed and stored in the device during enrolment;
revealing the concealed verification data and sending it to the device; and applying, at the device, a noninvertible function to the verification data and comparing an output of the function to a parameter stored in the device, wherein the step of deriving response data and comparing the derived response data with response data received from the verifier is performed if the output of the function corresponds to the stored parameter.

5. The method of claim 4, wherein the step of receiving concealed verification data at the verifier (210) further comprises the step of:
checking, at the verifier, whether the concealed verification data is provided with a valid digital signature and, if so, performing the step of revealing the concealed verification data and sending it to the device (201).

6. The method according to claim 1, wherein said response data comprises a response of the physical token (102).

7. The method according to claim 1, wherein said response data comprises processed data based on a response of the physical token (102) and noise-correcting data.

8. The method according to claim 7, further comprising the steps of:
encrypting the noise-correcting data; and
storing the encrypted noise-correcting data in the device (101, 201).

9. The method according to claim 1, wherein the physical token (102) is a physical uncloneable function.

10. (canceled)

11. The method according to claim 1, wherein the physical token (102) is cryptographically bound to the device (101) in which it is comprised.

12. The method according to claim 11, further comprising the steps of:
associating response data of the physical token (102) with an identifier of the device (101) in which the token is comprised; and
concealing the data created by the association and storing the concealed data in the device.

13. (canceled)

14. (canceled)

15. (canceled)

16. The method according to claim 1, wherein the step of updating data that was stored in the device (101, 201) during enrolment comprises the steps of:
concealing, at the verifier (210), the received response data derived from the second challenge; and
replacing, in the device, the concealed second set of response data stored in the device during enrolment with the concealed response data derived from the second challenge.

17. The method according to claim 16, further comprising the step of:
receiving, at the verifier (210), the response data derived from the physical token (102) by using the first challenge;
concealing, at the verifier, said received response data derived from the first challenge; and
replacing, in the device (101, 201), the first set of concealed response data stored in the device during enrolment with the concealed response data derived from the first challenge.

18. (canceled)

19. A system for performing authentication, said system comprising:
a verifier (210); and
a device (101, 201) comprising a physical token (102); wherein:
the verifier is arranged to
receive, from the device, a first set of concealed response data, which response data was derived from the physical token, concealed and stored in the device during enrolment;
reveal the concealed response data; and
send it to the device;
the device is arranged to
derive response data by challenging the physical token with a first challenge that was employed to derive the first set of response data;
compare the derived response data with the first set of response data received from the verifier;
derive response data by challenging, if the derived response data corresponds to the first response data set received from the verifier, the physical token with a second challenge that was employed to derive a second set of response data from the physical token and which second set was concealed and stored in the device during enrolment; and
send the second set of concealed response data and the response data derived from the second challenge to the verifier;
the verifier is further arranged to:
reveal the second set of concealed response data and compare the second set of response data with the response data derived from the second challenge, wherein the device is considered to be authenticated if there is correspondence between the two data sets.

20. The system of claim 19, wherein the verifier (210) further is arranged to check whether the first set of concealed response data is provided with a valid digital signature and, if so, reveal the first set of concealed data and send it to the device (201).

21. The system of claim 19, wherein the verifier (210) further is arranged to check whether the second set of concealed response data is provided with a valid digital signature and, if so, reveal the second set of concealed response data and compare the second set of response data with the response data derived from the second challenge.

22. The system of claim 19, wherein
the verifier (210) further is arranged to receive concealed verification data from the device, which verification data was concealed and stored in the device during enrolment, to reveal the concealed verification data and to send it to the device; and
the device (201) further is arranged to apply a noninvertible function to the verification data and compare an output of the function to a parameter stored in the device, wherein deriving response data and comparing the derived response data with response data received from the verifier is performed if the output of the function corresponds to the stored parameter.

23. (canceled)

24. (canceled)

25. A device (101) comprising a physical token (102) which provides measurable parameters, said device further comprising:
sensor elements (103) for measuring the parameters provided by the physical token;
logic circuitry (108) for processing data supplied to it in a noninvertible function;
at least one memory (106, 107) for storing concealed response data derived from said physical token (102) during enrolment of the device; and
communication means (105, 109) for communicating with an external entity.

26. The device (101) according to claim 25, wherein said physical token (102) comprises a coating which at least partly covers the device.

27. The device (101) according to claim 25, wherein said device is a radio frequency identification (RFID) tag.

28. (canceled)
